(19) United States
(12) Patent Application Publication
(10) Pub. No.: US 2016/0005115 A1
(43) Pub. Date: Jan. 7, 2016

(54) METHOD AND SYSTEM FOR SUPPORTING LOAN TRANSACTION BY USING ADDRESS BOOK, AND NON-TEMPORARY COMPUTER-READABLE RECORDING MEDIUM

(71) Applicant: Eugene Maeng KIM, (US)

(72) Inventor: Eugene Maeng KIM, Jersey City, NJ (US)

(21) Appl. No.: 14/770,961

(22) PCT Filed: Feb. 27, 2014
(86) PCT No.: PCT/KR2014/001645

§ 371 Date: Aug. 27, 2015

(30) Foreign Application Priority Data
Feb. 27, 2013 (KR) 10-2013-0021518

(51) Int. Cl. G06Q 40/02

(52) U.S. Cl. CPC G06Q 40/025

(57) ABSTRACT

In accordance with one form of this invention, a method to support LBT using address book provides functions: generating LBT address book per user referencing users' address books acquired from the users' terminal devices; sending the locate message that contains the first user's securities desired to be borrowed or lent, acquired by referencing locate requests from the first user's terminal device, to the terminal device of the second user listed on the first user's LBT address book; and providing communication interface supporting the first user and the second users to exchange negotiation messages regarding LBT contracts for the securities desired to be borrowed or lent.

### FIELDS OF TECHNOLOGY

This invention is about a method/system for supporting lending and borrowing transaction using address unit and non-transitory computer-readable recording medium.

### BACKGROUND TECHNOLOGY

Securities Lending & Borrowing Transaction (“LBT”) means a contract formed where a lender promises to transfer the ownership of certain securities and a borrower promises to return the same quantities of those securities in the future. Once a Securities LBT is formed, right to dispose of and right to profit from those securities are transferred to the borrower, and in consideration of these rights, the lender is compensated with economic benefit the borrower could have received if he or she had not executed the LBT, such as cash dividends, bonus shares or rights issue.

LBT is used to accomplish various purposes including: short selling; arbitrage transaction through short selling; collateral usage; fail coverage; recall coverage; refinancing at a lower rate; and replacement of existing LBT with more stable supply.

LBT can be executed through an intermediary, agent or exchange, depending on how a borrower and a lender (“Parties”) agreed. In some countries, the transaction can be settled directly between a borrower and a lender. Generally, LBT is executed through: negotiated transaction method where the Parties first confirm the terms of the transaction and then make a lending/borrowing request accordingly; bid offer method where the Parties openly compete under certain standards (rewarding lower lending rate, higher borrow rate or the timing of a lending or borrowing request). The aforementioned negotiated transaction method shall include all types of LBTs that is premised on negotiation between the Parties.

In most LBTs (except for the ones that are executed through the bid offer method), the Parties negotiate the terms of the transaction such as the borrow rate, collateral rate or date of settlement without assistance of the said intermediary, agent, or exchange. When they reach agreement on the terms, borrow request is sent through intermediary, agent, or exchange (or directly) to the lender; subsequently, the LBT contract is made. The borrower then deposits collaterals to the said intermediary, agent, or exchange (or directly to the lender), and then the lender transfers the shares under this transaction to the borrower in accordance with the terms of this LBT.

Thus, under the negotiated transaction method, LBT will go through several processes: negotiation, agreement, confirmation, establishing collaterals and share transfer. Also, most LBTs for shares or other securities between offshore parties or between offshore and onshore parties, using the negotiated transaction method, and only a few LBTs use bid offer method because it is difficult for borrowing party to access information on securities to be borrowed or lent and because there is no way for the Parties to negotiate a borrow fee and other relevant terms to without an opportunity to negotiate.

Over the last few years, LBTs in its amount and in volume have increased dramatically. However, the Parties have used the telephone, messenger, Bloomberg terminal or email to negotiate the terms of the LBTs due to absence of integrated system that can connect the Parties and other participants of the transaction. Accordingly, following issues were raised in relation to LBT.

Under existing methods of LBT, it is difficult to group an address book because contact information of LBT participants are not centralized, hence the communication channel cannot be unified. More specifically, contact information of all participants (onshore/onshore lenders and borrowers) were not stored in one location. This often has led to communication problems as it was difficult to find certain participant's contact information or to update the list with the most recent contact information. Also, whereas LBT participants with similar attribute should be grouped together so that they can communicate more conveniently with other participants, due to absence of unified system managing LBT participants' contact information, this was not possible.

Using the existing system (as aforementioned), in case of negotiated transaction method, LBT contract is presumed to be made through the negotiation process before the request was sent to execute the transaction. Thus, these transaction using the existing method will need to use various channels such as the telephone, messenger, Bloomberg terminal or email to negotiate the LBT contract in relation with individual shares or small units of baskets of shares. On occasion, in accordance with preference by institution or individuals, communication channels may differ. Due to the circumstance where communication channels through which LBT participants had to communicate were not unified, it has been pointed out that a significant amount of time and efforts were wasted in executing LBT contract and considerable costs were incurred in establishing their own communication system.

Meanwhile, in case of negotiated transaction method, a borrower needs to know who has what kind of securities to lend, but a lender usually does not disclose details of securities for LBT to protect their information, and thus a borrower will not know about the said information unless he/she asks the said potential lender about the securities for LBT and confirm whether the lender holds those securities. Also, under the same method, the Parties, before issuing borrow request, have to negotiate and agree on the terms in regards to the lending/borrowing rate, volume of securities to be borrowed or lent, LBT period, recall risk and corporate action. However, information on lenders and borrowers as well as volume of securities to be borrowed or lent is not centralized and there is no system that can systemize the negotiation process.

In addition, using the existing system, the address book cannot be managed comprehensively and LBTs are executed through various communication devices not compatible with one another. Under this circumstance, it is difficult for a borrower to negotiate with multiple lenders (or lenders in one or more groups), or a lender to negotiate with multiple borrowers (or borrowers in one or more groups) simultaneously. Thus, negotiation has been through one-on-one negotiation only. Here, one-to-many communication does not mean all participants have access to all communication among the participants. Instead, it means the “one” can refer to its communication with multiple participants but each of the multiple participants can only refer to the communication between the “one” and the corresponding participant.

Moreover, the existing system cannot integrate and manage records of negotiation process or the details of LBTs, negotiated or executed through various communication channels that are not compatible with one another. Thus, LBT participants have difficulties searching for the information on the past LBT records and accordingly cannot easily understand the trend of their LBTs based on the historical information, jeopardizing the decision making process.

Also, as information on confirmed LBT contracts are processed through various channels under the existing system, data format will be different depending on which channel the participants used and thus it may be difficult to find out the source of the information. For instance, in case that LBT contract was confirmed by telephone, it may well practically be very difficult to confirm the details of the contract by looking into the phone records.

Meanwhile, most countries, their relevant regulation requires a borrower to have ownership of the shares to be borrowed before lodging a corresponding request to short sell the shares. The ownership of the borrowed shares is recognized at the point where the borrowing of the said share is completed or where the LBT contract on those shares is confirmed. Accordingly, most institutions place an offer as soon as the LBT contract is confirmed, but the completion of short selling is oftentimes delayed as it takes considerable time to obtain the LBT borrow confirmation that can substantiate the contract on top of going through other LBT contract processes such as searching for shares to be borrowed, negotiation and obtaining confirmation.

The aforementioned inefficiency can be eliminated when bid offer method is used but the method has its own restraint in its not being able to fine-tune the specific terms of the LBT contract due to lack of the negotiation process between the Parties.

Thus, it became necessary to use LBT assistance system that can confirm the transaction more swiftly and efficiently by using the address book throughout the locate as well as negotiation process between the Parties (or automatically confirm in case that the Parties' terms are met).

### DETAILS OF THE INVENTION

### Technological Objective

This invention aims to resolve problems of the existing system as aforementioned.

This invention also aims to accomplish securities LBT contract to be processed by sharing information on securities desired to be borrowed or lent as well as, negotiating and confirming the transaction in a more efficient and swift manner.

Another purpose of this invention is to be able to transfer swiftly the information of the confirmed LBT contract to the external system such as the contract settlement system or securities trading system.

Lastly, this invention aims to unify and automate LBT contract confirmation process by facilitating various types of locate and negotiation using integrated LBT address book which covers all offshore as well as onshore LBT participants.

### Development Measures

Core structure of this invention to meet the purposes is as follows.

One form of this invention provides following measures to support LBT using address book: (a) generating LBT address book for each of the users including at least one user, referencing address book information acquired through at least one user terminal device; (b) transferring the locate message that contains the abovementioned first user's securities desired to be borrowed or lent, acquired by referencing locate requests from the first user's terminal device, to at least one terminal device of the second user listed on the first user's LBT address book; and (c) providing communication interface supporting the first user and at least one of the second users as abovementioned, to exchange negotiation messages regarding LBT contracts for the securities desired to be borrowed or lent.

Another form of this invention provides following measures to support LBT using address book: (a) generating LBT address book for each of the users including at least one user, referencing address book information acquired through at least one user terminal device; (b) transferring the locate message that contains the abovementioned first user's securities desired to be borrowed or lent, acquired by referencing locate requests from the first user's terminal device, to at least one terminal device of the second user listed on the first user's LBT address book; and (c) when conditions of a LBT contract included in the locate message(s) coincide with those predetermined by at least one of the second users, the LBT contract to be automatically confirmed between the first user and at least one of the second users.

According to another form of this invention, it is a system to support LBT using address book providing following units: address management unit generating LBT address book for each of the users including at least one user, acquired by referencing address book information from at least one user terminal device; LBT locate management unit transmitting the locate message that contains the abovementioned first user's securities desired to be borrowed or lent, acquired by referencing locate requests from the first user's terminal device, to at least one terminal device of the second user listed on the first user's LBT address book; and LBT negotiation management unit providing communication interface supporting the first user and at least one of the second users as abovementioned, to exchange negotiation messages regarding LBT contracts for the securities desired to be borrowed or lent.

According to another form of this invention, it is a system to support LBT using address book providing following units: address management unit generating LBT address book for each of the users including at least one user, acquired by referencing address book information from at least one user terminal device; LBT locate management transferring the locate message that contains the abovementioned first user's securities desired to be borrowed or lent, acquired by referencing locate requests from the first user's terminal device, to at least one terminal device of the second user listed on the first user's LBT address book; and LBT negotiation management unit that automatically confirms the LBT contract between the first user and at least one of the second users, when conditions of a LBT contract included in the locate message(s) coincide with those predetermined by at least one of the second users.

In addition, the invention provides other measures and system for implementing the invention as well as computer-readable recording medium for recording computer programs for implementing the abovementioned measures.

### Effect of this Invention

This invention will effectuate the processes of: searching securities desired to be borrowed or lent; sharing information on securities desired to be borrowed or lent between borrowers and lenders; and negotiation and confirmation, to be more efficiently and swiftly completed. This effect will lead borrower and lenders into acquiring sufficient information on securities to be borrowed or lent, which will secure borrowers and lenders the most appropriate securities (to be borrowed or lent) and have an effect of accomplishing confirmation of the transaction.

Also, this invention says lenders and borrowers will easily be able to manage securities to be lent or borrowed subject to LBT as information relating to LBT confirmation can be transferred to external systems such as contract settlement system and securities trading system swiftly. In particular, a borrower is able to swiftly send an order to those external systems to short-sell the securities borrowed.

According to this invention, onshore and offshore institutions which are required to submit an applicable form to a regulator in charge of those matters in regards to the LBTs, also can transfer the form automatically to the intermediaries, exchange, and custodian banks' system. Thus, the institutions' convenience will be enhanced and the LBT will be processed more speedily.

Finally, through this invention, a participant will be able to easily negotiate the LBT contracts with counterparty by using integrated LBT address book. Also, various information on LBT contracts will be managed automatically and centrally through the invention.

### DESCRIPTION OF DIAGRAM

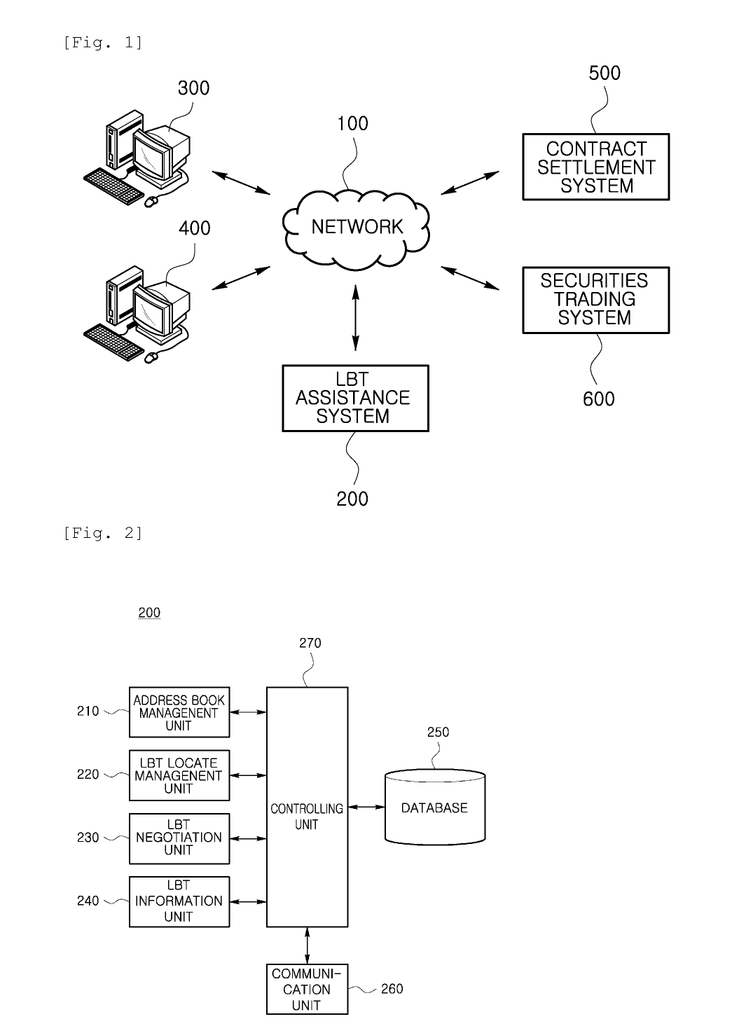

FIG. 1 depicts overall structure of the whole system that assists LBT in accordance with the invention.

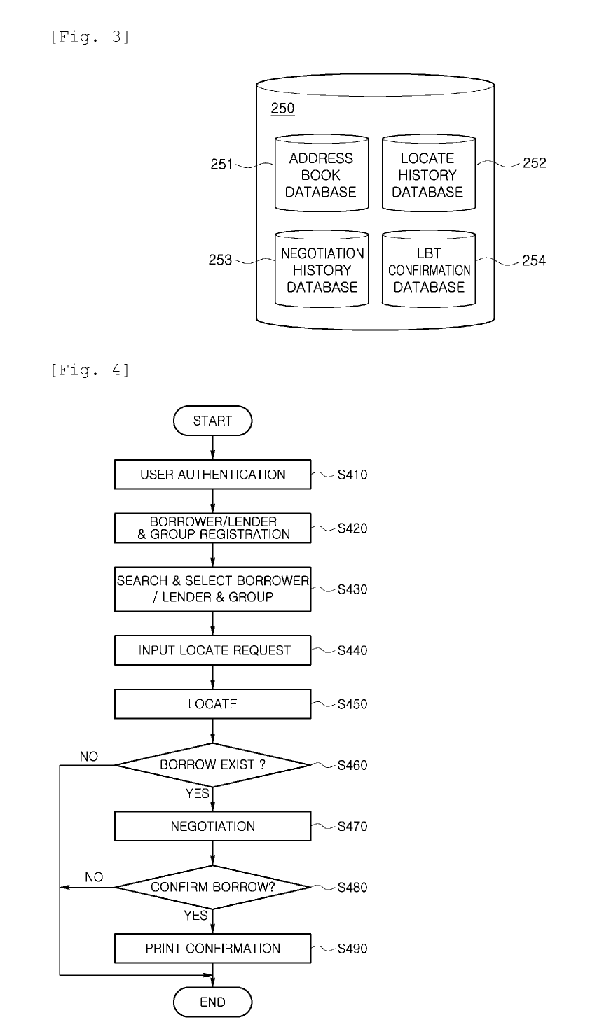

FIGS. 2 and 3 specifically depict the internal structure of LBT Assistance System (200) in accordance with the illustrative implementation of the invention.

FIG. 4 illustrates overall process of confirming LBT through the negotiation process with the other user in the LBT address book.

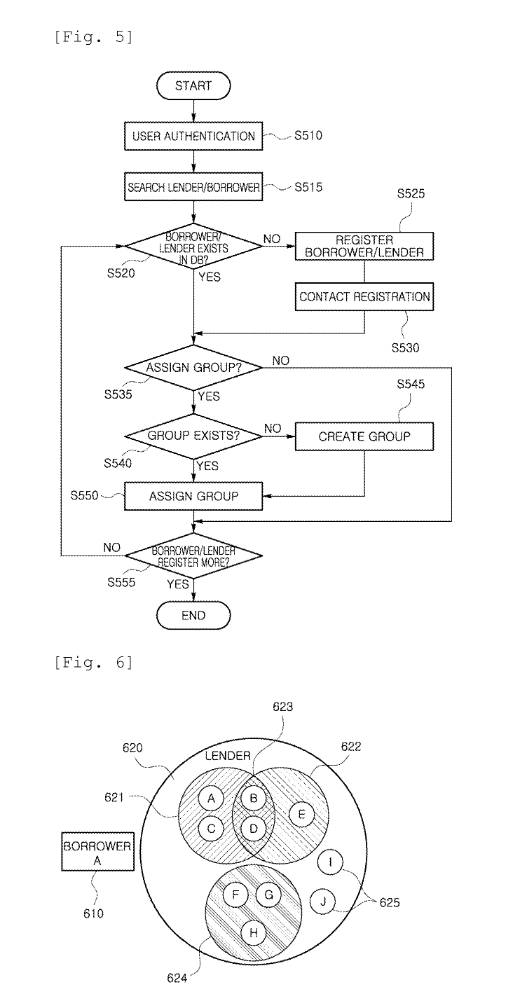

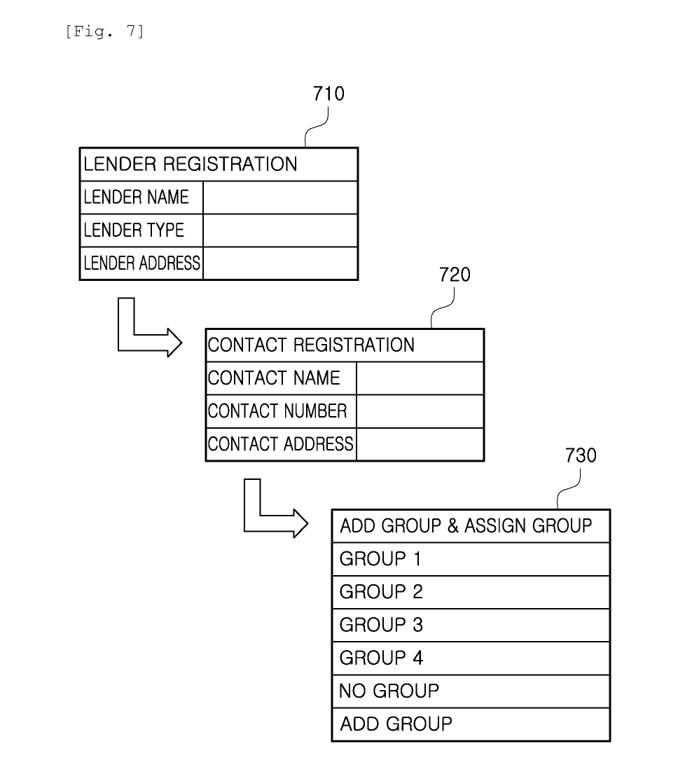

FIG. 5 is a realization of process for managing the LBT address book in accordance with the invention.

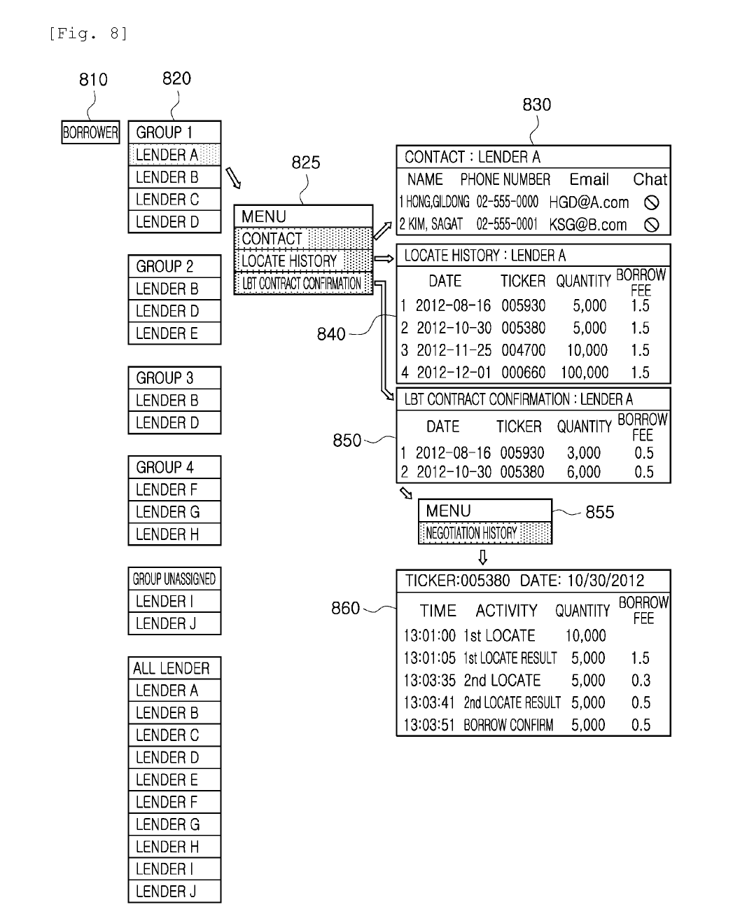

FIG. 6 is a diagram that illustrates the composition of the grouped users within the LBT address book.

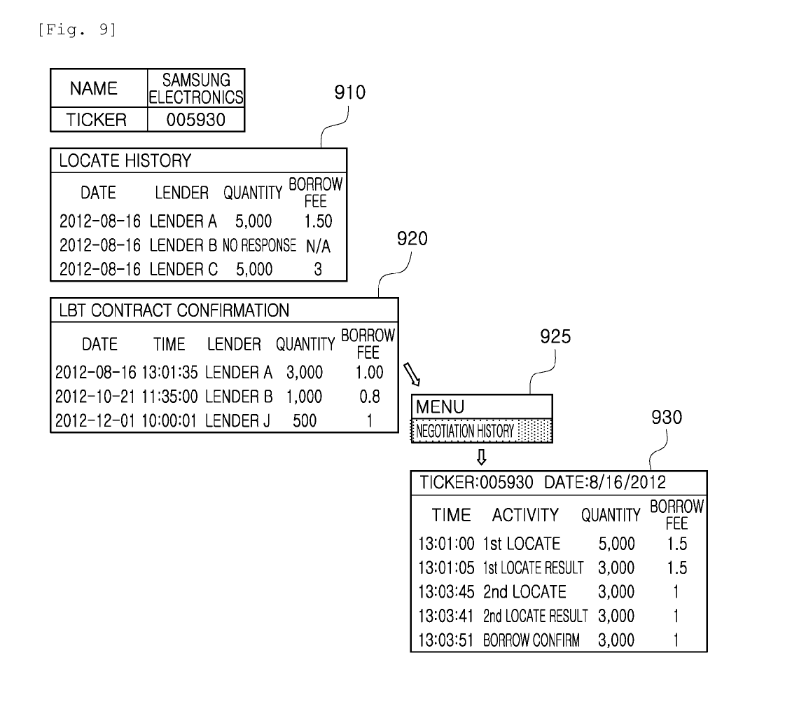

FIG. 7 is an example of a user interface structure that enables users to enter data on lender, contact person and group information in the address book.

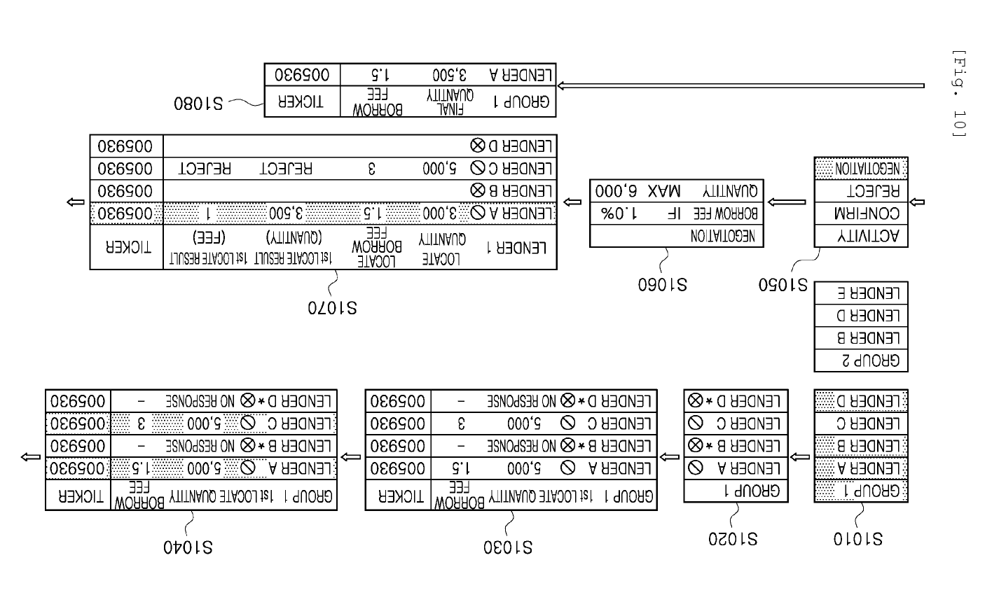

FIGS. 8 and 9 are diagrams illustrating user (borrower's) interface structure that can enable the borrower to refer to lender/borrower information in the address book as well as lender/borrower locate history and transaction and negotiation details.

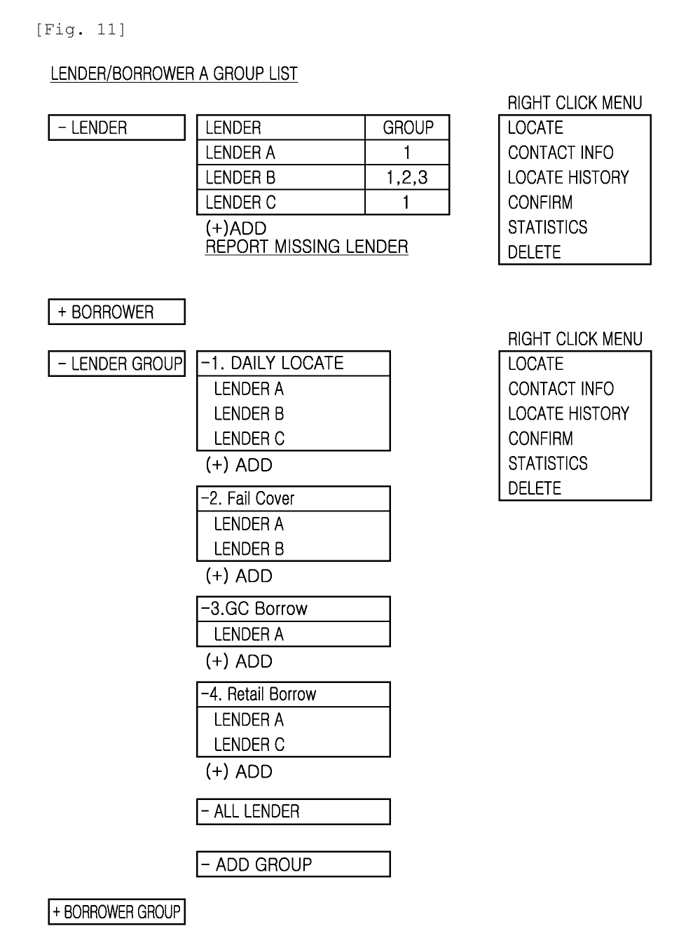

FIG. 10 illustrates (borrower's) user interface structure for assisting a borrower to put a lender locate for LBT, negotiate and confirm the LBT contracts.

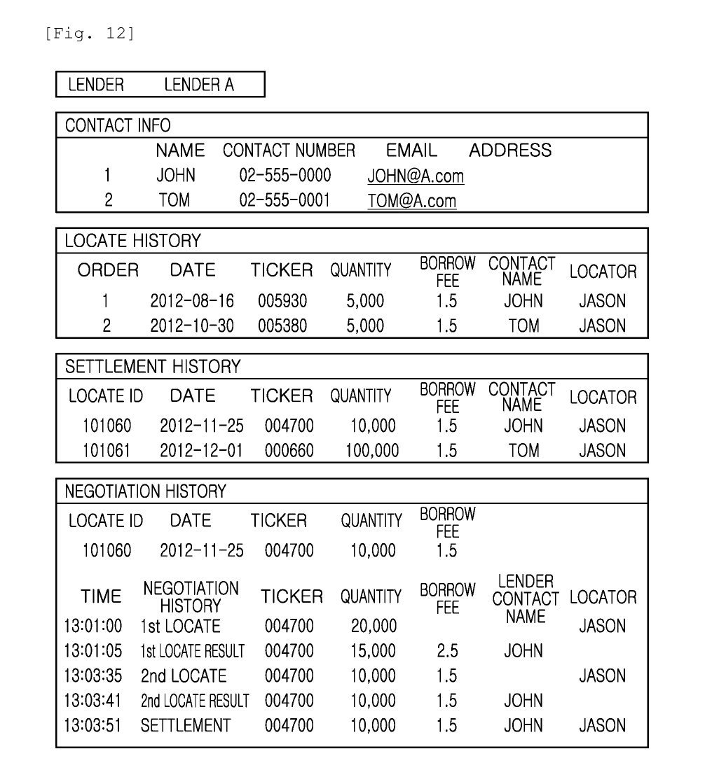

FIG. 11 illustrates user interface structure providing lists of lenders, borrowers, and groups.

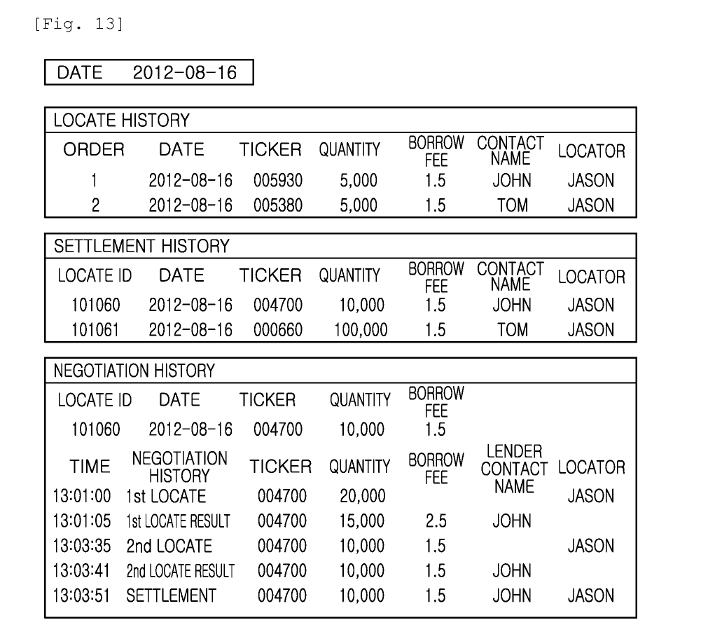

FIG. 12 illustrates user interface structure providing LBT history per lender.

FIG. 13 illustrates user interface structure providing LBT history per date.

### DESCRIPTION OF NUMBERS

100: Network
200: LBT Assistance System
210: Address Management Unit
220: LBT Locate Management Unit
230: LBT Negotiation Management Unit
240: LBT Information Management Unit
250: Database
251: Address Book Database
252: Locate History Database
253: Negotiation History Database
254: LBT Confirmation Database
260: Communication Unit
270: Controlling Unit
300: Borrower's terminal device
400: Lender's terminal device
500: Contract Settlement System
600: Securities Trading System

### EXAMPLES OF IMPLEMENTATION OF THE INVENTION

Explanations on the invention detailed as follows are illustrative implementation examples of the invention, which shall be referred to the figures depicting the processes or structures. These illustrative implementations shall be explained in sufficient detail so that skilled persons can implement. Illustrative implementation examples of this invention may be different but not necessarily mutually exclusive. For instance, the forms, structure or features recorded in this Specification can be realized by transforming one implementation example to another implementation example as long as they are in the spirit and scope of the invention. Also, it needs to be understood that location or configuration of the components for each illustrative example may be changed as long as it is in the spirit and scope of this invention. Accordingly, following detailed explanations are not presented to limit the implementation and thus the scope of this invention is considered to cover the scope claimed and the entire scope equivalent to the scope claimed. The Numbers shown in Diagrams represents the same or similar components.

Explanations on the invention detailed as follows are illustrative implementation examples of the invention aiming at enabling a person with reasonable knowledge in technology to implement this invention, which will be referred to the figures depicting the processes or structures.

[Desirable Implementation Examples of this Invention]

Securities under this Specification means a certificate that expresses rights to demand certain amount of money or certain assets with value, indicating rights in property in accordance with the Commercial Act. The meaning of securities under his Specification does not limit the meaning under the Commercial Act or Securities or Exchange Act. The term “securities” here is interpreted most widely and thus refers to all kinds of assets that can be a subject of LBT. For instance, this Specification refers to listed stocks, unlisted stocks, bonds, beneficiary certificates, preemptive rights, financial products including beneficiary certificates, futures, derivatives including equity swaps, equity-linked securities, equity-linked warrants, bonds with warrants, convertible bonds, exchange traded funds as securities.

Structure of the Whole System

FIG. 1 depicts overall structure of the whole system that assists LBT in accordance with the invention.

As FIG. 1 has depicted, the whole system in accordance with the implementation example of this invention may be composed of Network (100), LBT Assistance System (200), borrower's terminal device (300), lender's terminal device (400), Contract Settlement System (500) and Securities Trading System (600).

First of all, network of this invention can be established through wire or wireless communication network and may be composed of various networks such as LAN (Local Area Network), MAN (Metropolitan Area Network) or WAN (Wide Area Network). Desirably, the Network (100) in this Specification may refer to internet or World Wide Web (WWW). However, the Network (100) is not confined to those and at least a part of the network may include wire/wireless data communication network, telephone network or wire/wireless television network. Meanwhile, Network (100) may, in some cases, include dedicated circuit (not in the Figures) of the securities exchange or that of a securities company.

Next, LBT Assistance System (200) can: generate LBT address book for each of the users including at least one user, acquired by referencing address book information from at least one user's terminal device; transfer the locate message that contains the first user's securities desired to be borrowed or lent, acquired by referencing locate requests from the first user's terminal device, to at least one terminal device of the second user listed on the first user's LBT address book; and provide communication interface supporting the first user and at least one of the second users as abovementioned, to exchange negotiation messages regarding LBT contracts for the securities desired to be borrowed or lent; and save information on the said LBT contract in predetermined format once the LBT contract between the first user and at least one of the second users is confirmed.

The details on composition of the LBT Assistance System (200) in accordance with this invention will be discussed in the later part (Composition of LBT Assistance System).

Next, borrower's terminal device (300) or lender's terminal device (400) shown in the illustration are devices that enable connection to the LBT Assistance System. The devices transfer address information entered in by a borrower or a lender and enables generating LBT address book. Also, locate information including securities desired to be borrowed or lent entered in by a borrower or a lender is transferred to the LBT Assistance System (200) which relays the locate messages to the said devices (300, 400). Lastly, the devices may assist in exchanging negotiation message in relation to a LBT contract between a borrower and a lender using communication interface provided by the LBT Assistance System (200).

Meanwhile, borrower's terminal device (300) or lender's terminal device (400) shown in the illustration are digital appliance that can communicate through the Network (100) with connection, which includes smart phones, PDAs, personal computers (e.g. desktop, laptop, etc.), web pads, mobile phones
the device equipped with memory and micro-processor and thus containing calculation function may be used as the said devices (300, 400) in this invention. It may be necessary to include programs such as application, web browser, widget in a borrower's terminal device (300) or a lender's terminal device (400) shown in the illustration, in order to enable a borrower or a lender to exchange various types of information through the LBT Assistance System (200).

Next, once the contract is confirmed by LBT Assistance System (200), Contract Settlement System (500) shown in the illustration, receives the data in relation with the contract and actually settles the LBT contract between the borrower and the lender.

Next, once the contract is confirmed through the LBT Assistance System (200) or actually settled through Contract Settlement System (500), Securities Trading System (600) shown in the illustration of this invention receives the data in relation with the contract and enables the borrower to send an order to short-sell the securities borrowed. For instance, Securities Trading System (600) may be a system operated by securities exchange or a securities company.

Composition of LBT Assistance System

This part explains internal composition and the function of each element of LBT Assistance System (200) in accordance with the implementation of the invention.

FIGS. 2 and 3 specifically depict the internal structure of LBT Assistance System (200) in accordance with the illustrative implementation of the invention.

As shown in FIGS. 2 and 3, LBT Assistance System (200) in accordance with the illustrative implementation of the invention may be composed of Address Management Unit (210), LBT Locate Management Unit (220), LBT Negotiation Management Unit (230), LBT Information Management Unit (240), Database (250), Communication Unit (260) and Controlling Unit (270). Here, Database (250) may be composed of Address Book Database (251), Locate History Database (252), Negotiation History Database and LBT Confirmation Database. According to an illustrative implementation of this invention, at least some of following units—Address Management Unit (210), LBT Locate Management Unit (220), LBT Negotiation Management Unit (230), LBT Information Management Unit (240), Database (250), Communication Unit (260) and Controlling Unit (270), may be program modules that communicate with borrower's terminal device (300), lender's terminal device (400), Contract Settlement System (500) or Securities Trading System (600). These program modules may be included in LBT Assistance System (200) in the form of operating system, application program module or other program module and physically stored in various types of memory device. Also, this program module may be stored in remote-controllable memory device which communicates with LBT Assistance System (200). Meanwhile, this program module may play certain function which will be explained in the later part in accordance with this invention or may implement certain type of abstract data including (but not limited to) routine, sub-routine, program, object, component or data structure.

First of all, in accordance with an illustrative implementation of this invention, Address Management Unit (210) may generate LBT address book for each of the users including at least one user, acquired by referencing address book information from Borrower's terminal device (300) or Lender's terminal device (400).

More specifically, Address Management Unit (210) in accordance with an illustrative implementation of this invention enables a user (borrower or lender) to add, delete or modify information of counterpart users in the LBT address book, who can potentially become a counterparty to LBTs. In case where the user registered in the LBT address book is an institution rather than an individual, Address Management Unit (210) in accordance with an illustrative implementation of this invention may enable a user to designate a contact person of that institution and to add, delete or modify information of that person in the address book.

Also, Address Management Unit (210) in accordance with an illustrative implementation of this invention enables a user to make at least one group with at least one of counterpart users registered in the user's LBT address book. For instance, where a user is a borrower, a group may be formed in the address book to include at least one of counterpart users registered in the address book in the same group, such as, onshore asset managements, onshore securities companies or onshore pension funds. As later explained, LBT address book may be used in processing one-to-many locate or one-to-many negotiation process. For example, a user may send the locate message to multiple counterpart users simultaneously.

Next, in accordance with an illustrative implementation of this invention, LBT Locate Management Unit (220) enables a user to send a locate (it happens when a borrower sends a borrow request to a lender or a lender sends a lending request to a borrower) to at least one of counterpart users recorded in the address book.

More specifically, LBT Locate Management Unit (220) in accordance with an illustrative implementation of this invention enables: a user who wishes to borrow securities to send a locate message containing information on securities desired to be borrowed to at least one counterpart user; or a user who wishes to lend securities to send a locate message containing information on securities desired to be lent to at least one counterpart user.

Also, LBT Locate Management Unit (220) in accordance with an illustrative implementation of this invention enables one-to-many locate process by making a user to send a locate message containing information on securities desired to be borrowed or lent to multiple counterpart users simultaneously. In such case, LBT Locate Management Unit (220) enables multiple counterpart users who received the locate messages to enter correspondence and accordingly the user who originally sent the locate message may receive the said corresponding message through the multiple counterparts' terminal devices.

Locate message in accordance with an illustrative implementation of this invention contains information on securities desired to be borrowed or lent. For example, name and quantity of the securities desired to be borrowed or lent, desired borrow rate, source of borrow—offshore or onshore, possibility of recall, corporate action liability, expected holding period, collateral type, automatic contract confirmation preference of securities desired to be borrowed or lent may be included. The information on such securities may contain securities identifier, that is, Ticker, SEDOL (Stock Exchange Daily Official List) or CUSIP (Committee on Uniform Securities Identification Procedure (in order to identify securities.

Also, in accordance with an illustrative implementation of this invention, if securities desired to be borrowed or lent is an option such as equity swap the information on such securities may contain information on leverage ratio, collateral rate, rebate on cash collateral, lending and borrowing rate, commission, financing benchmark, spread on top of the financing benchmark, credit rating, and swap reset period and reset date.

Also, in accordance with an illustrative implementation of this invention, locate message can be sent in various modes or forms. For example, a mode where a user enters in information on securities desired to be borrowed or lent in person, information in the form of text file or eXtensible Markup Language (XML) that can be sent by using various protocols may be brought in.

Meanwhile, content of information in locate message and transfer modes of that locate message in accordance with this invention may not be confined to what were brought up above. They may always be added, changed or deleted in order to best accomplish the purpose of this invention, for the record. Also, content of information in the locate message and transfer modes of that locate message in accordance with this invention similarly applied to those of the correspondence message sent as a response to a locate message.

Next, LBT Negotiation Management Unit (230) in accordance with an illustrative implementation of this invention can provide communication interface supporting a user who wishes to borrow securities and a user who wishes to lend securities in processing negotiation. Also, LBT Negotiation Management Unit (230) in accordance with an illustrative implementation of this invention may enable the users confirm their LBT contract in case where the negotiation on the terms of the LBT contract between the Parties are agreed upon.

More specifically, LBT Negotiation Management Unit (230) in accordance with an illustrative implementation of this invention can support users (sender and receiver of the locate message ( to exchange negotiation messages regarding the details of LBT contracts for the securities desired to be borrowed or lent. For instance, the details that may be contained in the negotiation messages may include name and quantity of the securities in demand, source of borrow—offshore or onshore, possibility of recall, corporate action liability, date of contract and collateral type. Also, in case where the LBT is a term borrow which does not allow recall request for certain period of time, the negotiation of the term (period of time ( may be processed. If a transaction takes a form of security-backed loans (such as financing trade or term financing) through which a lender takes out a loan or lends money through collateralization of the securities, information on financing benchmark, spread on top of the financing benchmark, or financing period may be included.

Also, LBT Negotiation Management Unit (230) in accordance with an illustrative implementation of this invention enables a user to negotiate with multiple users on the terms of LBT and accordingly the user can send negotiation message to multiple counterpart users. In case of one-to-many negotiation, an illustrative implementation of this invention shows that a user can refer to all negotiation messages he/she sent to counterpart users while the counterpart users can check only the messages they have received.

Also, in accordance with an illustrative implementation of this invention, pre-defined form of phrases with the meaning of conditioned-upon (e.g. IF, MAX, MIN, etc.), confirmation, hold or reject may be contained in those negotiation messages, or those may take an online chatting (messenger) form.

Also, LBT Negotiation Management Unit (230) in accordance with an illustrative implementation of this invention enables details of negotiation such as locate message, response message, and negotiation message exchanged between the users to be saved in Negotiation History Database (253). When there are requests or queries on the negotiation history, it can provide the information on the details of negotiation saved in the Database. Storing, searching, or providing the history of requests or queries may be conducted in terms of lender, borrower, securities type or date.

For example, information on the details of negotiation that LBT Negotiation Management Unit (230) in accordance with an illustrative implementation of this invention can save, includes name and quantity of the securities in demand, desired borrow rate, source of borrow—offshore or onshore, possibility of recall, corporate action liability, date of contract and collateral type. Also, in case where the LBT is a term borrow which does not allow recall request for certain period of time, the details of the term (period of time ( may be saved and if a transaction takes a form of security-backed loans (such as financing trade or term financing) information on financing benchmark, spread on top of the financing benchmark or financing period may be saved.

Meanwhile, in accordance with another illustrative implementation of this invention, LBT Negotiation Management Unit (230) supports the function of automatic confirmation of the LBT contacts between users who sent the locate message and users who received the message. More specifically, in accordance with another illustrative implementation of this invention, where Parties agreed upon the automatic confirmation, if terms of LBT contract of a user's locate message conform to reserved terms of another user's LBT contract, LBT Negotiation Management Unit (230) facilitates the users to confirm LBT contracts between a user and the respondent user.

Next, in accordance with another illustrative implementation of this invention, LBT Information Management Unit (240), once a LBT contract is confirmed between the users, can save the identifier of the confirmed LBT contract as well as detailed information on the LBT at LBT Confirmation Database(254). For example, information on confirmed LBT contract includes the securities identification number of securities lent or borrowed subject to LBT, name, quantities, amount, price, lending and borrowing rate, dividend, corporate action, source of borrow—offshore or onshore, possibility of recall, stability, IRC (International Registration Code (, type of the lender of the securities (securities companies, advisory firms, asset management companies, etc.) and type of collaterals. Also, if the securities lent or borrowed subject to LBT is an option product such as equity swap, information on LBT contract includes leverage ratio, collateral rate, rebate on cash collateral, lending and borrowing rate, transaction fee, benchmark, spread on top of the financing benchmark (Spread), credit rating and reset period/date for swap rate.

For example, LBT contract that can be confirmed by this invention may include a term borrow which does not allow a recall request for a certain period of time or security-backed loans (such as financing trade or term financing).

However, information on LBT contract in accordance with this invention may not be confined to the list of contracts brought up above and the contract types on the list may always be added, changed or deleted in order to best accomplish the purpose of this invention, for the record.

Also, LBT Information Management Unit (240) in accordance with an illustrative implementation of this invention can implement the function of sending information on confirmed LBT contracts to external borrower terminal device (300), lender terminal device (400), Contract Settlement System (500) or Securities Trading System (600). Here, Contract Settlement System (500) or Securities Trading System (600), which will receive the information on the contract, may be designated by a user. Communication Unit (260) in accordance with an illustrative implementation of this invention can utilize various methods in sending information on LBT contract to external Contract Settlement System (500), terminal devices (300, 400) or Securities Trading System (600). For example, methods such as: sending information on LBT contract entered in to borrower terminal device (300); printing out or emailing information on LBT contract; or sending information on LBT contract modified in text files or XML (eXtensible Markup Language (through various protocols such as FTP (File Transfer Protocol) and FIX (Financial Information eXchange (can be utilized. As such, information on LBT contract can be transferred immediately to Contract Settlement System (500) and this enables swift settlement of the borrowed securities subject to LBT contract. Also, under the relevant regulation, a borrower should corroborate the fact that the confirmation of the LBT contract was made before sending a short-selling request in order to short-sell the borrowed securities. According to the LBT Information Management Unit (240) in accordance with an illustrative implementation of this invention, since information on confirmed LBT contract can be transferred immediately to Securities Trading System (600), the borrower can swiftly sell securities borrowed through LBT via Securities Trading System (600).

LBT Information Management Unit (240) in accordance with an illustrative implementation of this invention conducts a function of: automatically filling out a form for confirmed LBT contract if a party (particularly, a borrower) is onshore or offshore institution; sending this form to borrower's terminal device (300), lender's terminal device (400), Contract Settlement System (500), standing agent's terminal device (no figure), government authority's system (no figure), which can conduct automatic submission pre-trade if it was before confirmation of a contract or automatic submission post-trade if it was after confirmation of a contract in accordance with newly borrowed amount and the outstanding balance of borrowed amount. In accordance with an illustrative implementation of this invention, at least part of information on LBT contracts, which was explained in detail above, and electronic signature may be included in those forms automatically generated and sent. In particular, where a borrower is an offshore institution, if an amount exceeds certain amount per IRC (Investment Registration Certificate), a form must be submitted to the relevant government authority, and in accordance with an illustrative implementation of LBT Information Management Unit (240), the form can be automatically filled out and sent to the government authority's system, which can improve convenience of offshore institution participating in LBT and the offshore institution's LBT can be processed more swiftly.

In Database (250) in accordance with an illustrative implementation can save various information which was acquired, generated, modified and managed. Also, Database (250) in accordance with an illustrative implementation consists of Address Book Database (251), Locate History Database (252), Negotiation History Database (253) and LBT History Database (254), divided in terms of types of information saved. Also, in other database (no figure), even though the information is not directly relevant with the locate LBT, information on LBT and short-selling may be acquired, generated, modified or managed in order to generate various information in the form of raw or modified data. Although Database (250) is contained in LBT Assistance System (200) according to FIG. 2, Database (250) may be separated from LBT Assistance System (200) where necessary for a relevant skilled person who is implementing this invention. Meanwhile, Database (250) typically includes a recording medium that can be managed by a computer, which may include data records based on file system baring broad meaning in addition to its narrow meaning, or Database (250) may be simple assembly of logs as long as it can be searched and the data can be extracted.

Next, Communication Unit (260) in accordance with an illustrative implementation of this invention functions so as Address Management Unit (210), LBT Locate Management Unit (220), LBT Negotiation Management Unit (230) LBT Information Management Unit (240) or Database (250) may transfer or receive data.

Lastly, Controlling Unit (270) in accordance with an illustrative implementation of this invention controls flow of data among Address Management Unit (210), LBT Locate Management Unit (220), LBT Negotiation Management Unit (230) LBT Information Management Unit (240) Database (250) or Communication Unit (260). That is, Controlling Unit (270) in accordance with this invention, through controlling the data flow from/to the outside or data flow among each component of LBT Assistance System (200), can control Address Book Management Unit (210), LBT Locate Management Unit (220), LBT Negotiation Management Unit (230) LBT Information Management Unit (240) Database (250) or Communication Unit (260) to perform their own functions.

### Implementation Examples

Implementation examples were discovered in reference to FIGS. 4 and 13 as follows.

FIG. 4 illustrates overall confirmation process for a LBT contract which went through negotiation process between a user and another user in the user's LBT address book via LBT Assistance System (200). FIG. 4 shown by a diagram can be applied to all the implementation examples to be explained below.

FIG. 5 illustrates composition for managing LBT address book in accordance with the implementation example of this invention.

Referencing FIG. 5, a user (a borrower or a lender) may conduct user certification (S510) by using his/her terminal devices (300, 400). The user can search for another user whom the user wishes to include in his LBT address book to check whether that user is already saved in the address book (S515). The user may move another user from his/her address book to database of his/her LBT address book or add new user to the database of his/her LBT address book (S520, S525, S530) by directly entering the information. Next, a user can make groups with other users added to his/her LBT address book and can create a new group in case where the other user is to be included in that new group (S535, 540, S545, S550, S555). In the meantime, LBT Assistance System (200) in accordance with this invention may automatically include other qualified users in a group with reference to features of other users.

FIG. 6 illustrates composition of grouping process in LBT address book in accordance with the implementation example of this invention. For your reference, FIG. 6 shows grouping other users in a borrower's address book.

According to FIG. 6, a borrower (or A (610)) can put lenders (or J (620)) in various groups: for example, borrowers (A through D) may be grouped into Group 1 (621), borrowers (B, D and E) may be grouped into Group 2 (622), borrowers (B and D) may be grouped into Group 3 (623), borrowers (F through H) may be grouped into Group 4 (624) and borrowers (I and J (625)) may not be grouped into any of the groups.

FIG. 7 illustrates composition of user interface that allows a user (borrower) to enter information on lenders, contact persons, or groups within his/her LBT address book in accordance with the implementation example of this invention. Referencing the figure, a borrower may: enter lenders' information (710) such as name, features and address; enter information (720: such as name, phone number and email address) of a contact person where the lender is an institution; and put the lender in one of several groups where user interface to facilitate grouping is provided (730).

FIGS. 8 and 9 illustrate composition of user interface that allows a user (borrower) to enter information on lenders or borrowers, locate history between the user and the lenders (or borrowers) or information on transactions/negotiation history in accordance with the implementation example of this invention. With reference to FIG. 8, borrower A may look up for information on lenders per lender: for example, borrower A may refer to contact information on lender a, history of confirmed transactions may be found. With reference to FIG. 9, borrower A borrower A may look up for information on lenders per individual securities: for example, the user (borrower A) may refer to information on lenders (A, B and C) who received locate message on Samsung Electronics (identification number: 005930), as well as further information on negotiation history with these lenders.

FIG. 10 illustrates composition of user interface that supports a user (borrower) in lodging locate, conducting negotiation and confirming LBT contract with a lender in LBT address book in accordance with the implementation.

With reference to FIG. 10, the borrower may send locate messages for LBT to Group 1 lenders (A through D) selected from his/her LBT address book which is composed of Group 1 and Group 2 (S1010, S1020). Next, the borrower can confirm the result of the locate: for example, in response to the locate, a lender may enter information such as identification number, quantity and borrow rate. A lender not available will be marked as “X” where a lender who's available, marked as “/” (S1030). Then, the borrower can process further negotiation with lenders (A and C) who responded, selected with reference to the result of the locate. More specifically, the borrower may send confirm, reject or negotiate message to the lenders (S1050). For instance, the borrower may send a negotiation message indicating that the borrower intends to form a LBT contract in case that borrow rate is 1%, up to 6,000 shares, to A and C (S1060). Per negotiation, as lender C rejected the borrower's condition, lender A sent negotiation message accepting the terms (1% borrow rate ( for 3,500 of his/her shares. In this case, LBT transaction (quantities: 3,500 shares, borrow rate: 1%) between the borrower and the lender A may be confirmed (S1070, S1080). Finally, information on the LBT contract confirmed as above can be provided to the Parties' terminal devices (300, 400), Securities Trading System (600), system of a relevant government authority (no figure), as well as various external system such as intermediaries of LBTs, standing agents, executing brokers and securities exchanges.

FIG. 11 illustrates composition of user interface that provides lists of lenders, borrowers and groups in accordance with the implementation.

FIG. 12 illustrates composition of user interface that provides LBT history per lender in accordance with the implementation.

FIG. 13 illustrates composition of user interface that provides LBT history per date in accordance with the implementation.

Implementation examples of this invention as explained above are realized through programming language that can be implemented via various components of a computer and recorded in non-transitory computer-readable recording medium. The said computer-readable recording medium includes each of program language, data file, data structure, or in combination. Imperative program language recorded in computer-readable recording medium may be structured and customized for this invention or may be applicable as general knowledge for skilled persons in software area. Computer-readable recording medium includes customized hardware devices to implement magnetic medium such as hard disc, floppy disk, magnetic disc or magnetic tape, optical recording channel medium such as CD-ROM or DVD, magneto-optical medium such as floptical disk, imperative program language such as ROM, RAM or flash memory. Examples of imperative program language include machine language (or code) created by compiler as well as advanced language code that can be implemented by Interpreter via computer. Hardware devices may be transformed into one or more software modules, or the other way around, in order to conduct processes in accordance with this invention.

So far, this invention was explained in terms of specific components, limited implementation and figures such as specific composition elements. However, this was provided in order to assist general understanding of the invention, which is not limited to implementation examples explained above. Thus, persons with reasonable knowledge in technological area to which this invention belongs may seek to modify or transform the examples introduced.

Accordingly, realization of this invention should not be confined to the implementation examples explained above, and scope of claims of patent right as well as all of the scope considered to be uniformly or equivalently transformed scope may be within the scope of this invention.

1. A method implemented in a lending and borrowing transaction (LBT) assistance system for assisting in LBTs using an address book, the LBT assistance system comprising an address book management unit, a LBT locate management unit and a LBT negotiation management unit, and the method comprising the steps of:
(a) the address book management unit generating a LBT address book for each of the users including a plurality of users, with reference to the address book information obtained from at least one user terminal device;
(b) the LBT locate management unit transmitting a one-to-many locate message, including information on securities desired to be borrowed or lent by a first user, to each terminal device of a plurality of other users included in the LBT address book of the first user, with reference to a locate request obtained from a terminal device of the first user; and
(c) the LBT negotiation management unit providing a one-to-many communication interface for assisting the first user to send and receive a negotiation message, regarding a LBT contract for the securities desired to be borrowed or lent, to and from each of the plurality of other users,
wherein the one-to-many locate message includes information on at least one of an item name and amount of the securities desired to be borrowed or lent, desired borrow rate, source of borrow - offshore or onshore, possibility of recall, corporate action liability, date of contract, expected holding period, securities identifier, collateral type, and automatic contract confirmation preference;
the negotiation message includes information on at least one of an item name and amount of the securities being negotiated between the first user and the plurality of other users, desired maximum borrow rate, source of borrow—offshore or onshore, possibility of recall due to corporate action, corporate action liability, date of contract, expected holding period, securities identifier, type of desired lender, automatic contract confirmation preference, disclosure scope of information on the securities desired to be borrowed, collateral type, collateral rate, rebate of a lender or an intermediary institution for cash collateral, equity swap leverage ratio, lending and borrowing fee, equity swap commission, equity swap financing benchmark, spread added to the financing benchmark, credit rating, and equity swap reset period and date;
the first user is capable of sending the negotiation message to all of the plurality of other users, and the plurality of other users are capable of sending the negotiation message only to the first user; and
the terminal device of the first device is capable of receiving information on a response result in which, among the terminal devices of the plurality of other users having received the locate message or negotiation message, at least some of the terminal devices respond to the locate message or negotiation message, and transmitting an additional locate message or negotiation message to at least some of the terminal devices.

2. The method of claim 1, wherein the securities include at least one of listed stocks, unlisted stocks, bonds, beneficiary certificates, preemptive rights, financial instruments including beneficiary certificates, futures, financial derivatives including equity swap, equity-linked securities (ELSs), equity-linked warrants (ELWs), bonds with warrants (BW), convertible bonds (CBs), and exchange traded funds (ETFs).

3. The method of claim 1, wherein the plurality of other users included in the LBT address book of the first user are capable of being grouped into at least one group.

4. The method of claim 1, wherein if a specific user included in the LBT address book of the first user is an institution, the address book information on the specific user includes information on a contact person of the institution.

5. The method of claim 1, further comprising the step of:
(d) a LBT information management unit storing information on a breakdown of locates or negotiations between the first user and the plurality of other users.

6. The method of claim 1, further comprising the step of:
(e) a LBT information management unit storing, when the LBT contract is confirmed between the first user and the plurality of other users, information on the confirmed LBT contract.

7. The method of claim 1, further comprising the step of:
(f) a LBT information management unit providing, when the LBT contract is confirmed between the first user and the plurality of other users, information on the confirmed LBT contract to an external system functioning to settle the LBT contract.

8. The method of claim 1, further comprising the step of:
(g) a LBT information management unit providing, when the LBT contract is confirmed between the first user and the plurality of other users, information on the confirmed LBT contract to an external system functioning to allow the first user to sell the securities of the LBT contract on the premise that the LBT contract has been confirmed.

9. The method of claim 1, further comprising the step of:
(h) a LBT information management unit automatically creating, when at least one of the first user and the plurality of other users is an onshore or offshore institution and the LBT contract is confirmed between the first user and the plurality of other users, a declaration for the LBT contract with reference to information on the confirmed LBT contract, and transmitting the created declaration to a system of an institution requiring submission of the declaration.

10. A method implemented in a lending and borrowing transaction (LBT) assistance system for assisting in LBTs using an address book, the LBT assistance system comprising an address book management unit, a LBT locate management unit and a LBT negotiation management unit, and the method comprising the steps of:
(a) the address book management unit generating a LBT address book for each of the users including a plurality of users, with reference to address book information obtained from at least one user terminal device;
(b) the LBT locate management unit transmitting a one-to-many locate message, including information on securities desired to be borrowed or lent by a first user, to each terminal device of a plurality of other users included in the LBT address book of the first user, with reference to a locate request obtained from a terminal device of the first user; and
(c) the LBT negotiation management unit causing, when conditions of a LBT contract included in the one-to-many locate message coincide with those predetermined by the plurality of other users, the LBT contract to be automatically confirmed between the first user and each of the plurality of other users,
wherein the one-to-many locate message includes information on at least one of an item name and amount of the securities desired to be borrowed or lent, desired borrow rate, source of borrow - offshore or onshore, possibility of recall, corporate action liability, date of contract, expected holding period, securities identifier, collateral type, and automatic contract confirmation preference; and
the terminal device of the first device is capable of receiving information on a response result in which, among the terminal devices of the plurality of other users having received the locate message, at least some of the terminal devices respond to the locate message, and transmitting an additional locate message to at least some of the terminal devices.

11. A non-transitory computer-readable recording medium having stored thereon a computer program for executing the method of claim 1.

12. A system for assisting in lending and borrowing transactions (LBTs) using an address book, comprising:
an address book management unit for generating a LBT address book including a plurality of users for each of the users, with reference to address book information obtained from at least one user terminal device;
a LBT locate management unit for transmitting a one-to-many locate message, including information on securities desired to be borrowed or lent by a first user, to each terminal device of a plurality of other users included in the LBT address book of the first user, with reference to a locate request obtained from a terminal device of the first user; and
a LBT negotiation management unit for providing a one-to-many communication interface for assisting the first user to send and receive a negotiation message, regarding a LBT contract for the securities desired to be borrowed or lent, to and from each of the plurality of other users,
wherein the one-to-many locate message includes information on at least one of an item name and amount of the securities desired to be borrowed or lent, desired borrow rate, source of borrow - offshore or onshore quantity, possibility of recall, corporate action liability, date of contract, expected holding period, securities identifier, collateral type, and automatic contract confirmation preference;
the negotiation message includes information on at least one of an item name and amount of the securities being negotiated between the first user and the plurality of other users, desired maximum borrow rate, source of borrow—offshore or onshore, possibility of recall due to corporate action, corporate action liability, date of contract, expected holding period, securities identifier, type of desired lender, automatic contract confirmation preference, disclosure scope of information on the securities desired to be borrowed, collateral type, collateral rate, rebate of a lender or an intermediary institution for cash collateral, stock swap leverage ratio, lending and borrowing rate, equity swap commission, equity swap financing benchmark, spread added to the financing benchmark, credit rating, and equity swap reset period and date;
the first user is capable of sending the negotiation message to all of the plurality of other users, and the plurality of other users are capable of sending the negotiation message only to the first user; and
the terminal device of the first device is capable of receiving information on a response result in which, among the terminal devices of the plurality of other users having received the locate message or negotiation message, at least some of the terminal devices respond to the locate message or negotiation message, and transmitting an additional locate message or negotiation message to the at least some of the terminal devices.

13. The system of claim 12, wherein the securities include at least one of listed stocks, unlisted stocks, bonds, beneficiary certificates, preemptive rights, financial instruments including beneficiary certificates, futures, financial derivatives including equity swap, equity-linked securities (ELSs), equity-linked warrants (ELWs), bonds with warrants (BW), convertible bonds (CBs), and exchange traded funds (ETFs).

14. The system of claim 12, wherein the plurality of other users included in the LBT address book of the first user are capable of being grouped into at least one group.

15. The system of claim 12, wherein if a specific user included in the LBT address book of the first user is an institution, the address book information on the specific user includes information on a contact person of the institution.

16. The system of claim 12, further comprising:
a LBT information management unit for storing information on a breakdown of locates or negotiations between the first user and the plurality of other users.

17. The system of claim 12, further comprising:
a LBT information management unit for storing, when the LBT contract is confirmed between the first user and the plurality of other users, information on the confirmed LBT contract.

18. The system of claim 12, further comprising:
a LBT information management unit for providing, when the LBT contract is confirmed between the first user and the plurality of other users, information on the confirmed LBT contract to an external system functioning to settle the LBT contract.

19. The system of claim 12, further comprising:
a LBT information management unit for providing, when the LBT contract is confirmed between the first user and the plurality of other users, information on the confirmed LBT contract to an external system functioning to allow the first user to sell the securities of the LBT contract on the premise that the LBT contract has been confirmed.

20. (canceled)

21. A system for assisting in lending and borrowing transactions (LBTs) using an address book, comprising:
an address book management unit for generating a LBT address book including a plurality of users for each of the users, with reference to address book information obtained from at least one user terminal device;
a LBT locate management unit for transmitting a one-to-many locate message, including information on securities desired to be borrowed or lent by a first user, to each terminal device of a plurality of other users included in the LBT address book of the first user, with reference to a locate request obtained from a terminal device of the first user; and
a LBT negotiation management unit for causing, when conditions of a LBT contract included in the one-to-many locate message coincide with those predetermined by the plurality of other users, the LBT contract to be automatically confirmed between the first user and each of the plurality of other users,
wherein the one-to-many locate message includes information on at least one of an item name and amount of the securities desired to be borrowed or lent, desired borrow rate, source of borrow - offshore or onshore, possibility of recall, corporate action liability, date of contract, expected holding period, securities identifier, collateral type, and automatic contract confirmation preference; and
the terminal device of the first device is capable of receiving information on a response result in which, among the terminal devices of the plurality of other users having received the locate message, at least some of the terminal devices respond to the locate message, and transmitting an additional locate message to the at least some of the terminal devices.
